(19) United States
(12) Patent Application Publication
(10) Pub. No.: US 2026/0127904 A1
(43) Pub. Date: May 7, 2026

(54) DOCUMENT AUTHENTICATION BASED ON MODIFIED FONT DETECTION

(71) Applicant: IDEMIA PUBLIC SECURITY FRANCE, Courbevoie (FR)

(72) Inventors: Rein-lien HSU, Courbevoie (FR); Brian MARTIN, Courbevoie (FR)

(73) Assignee: IDEMIA PUBLIC SECURITY FRANCE, Courbevoie (FR)

(21) Appl. No.: 19/346,691

(22) Filed: Oct. 1, 2025

(30) Foreign Application Priority Data
Nov. 5, 2024 (FR) FR2412085

(51) Int. Cl. G06V 20/00; G06V 10/25; G06V 10/75; G06V 30/146; G06V 30/19; G06V 30/244; G06V 30/41

(52) U.S. Cl. CPC G06V 20/95; G06V 10/25; G06V 10/751; G06V 30/147; G06V 30/19013; G06V 30/245; G06V 30/41

(57) ABSTRACT

It is disclosed a method for authenticating a document (D), the document including a plurality of text fields, wherein an authentic document comprises, among the plurality of text fields, a plurality of characters printed according to a reference font, and at least one character, of determined location, being printed according to a font which is modified with respect to the reference font,
the method comprising:
   receiving an image of the document to be authenticated,
   extracting, from the image, a region of interest including the character of determined location,
   assessing discrepancies between the character included in the extracted region of interest and a model character, and
   determining whether or not the document is authentic based on the assessed discrepancies.

### TECHNICAL FIELD

This disclosure pertains to the field of document authentication and fraud detection in documents, such as ID documents.

### BACKGROUND ART

Identity documents are conventionally secured by incorporating a variety of security features. These features aim at ensuring authenticity, integrity and protection against fraud or tampering of the documents, and thus distinguishing an authentic document from a fraudulent one. During identity control, the presence and integrity of the security features is checked in order to authenticate the document. Security features may include for instance holograms, watermarks, microprinting, UV ink, etc.

A document, in particular an ID document, generally comprises both static text fields and variable text fields. Static text fields include text that does not vary according to the owner of the document, whereas variable text fields include text that varies according to the owner, also referred to as Personal Identifiable Information. Typically, a static text field does not contain any personal or document-related data, but may indicate the type of personal data that fills a neighboring variable text fields. In the case of an ID document, a static text field may include words such as “Name”, “Surname”, “Date of birth”, “Date of delivery”, “Signature”, etc. The static text fields may also include text identifying the document type and issuing authority.

Some documents may include dedicated fonts as a security feature, referred to as modified font. The modified font may have the same font style as the one used for the surrounding static texts—also called reference font, the modified font being different but close to the reference font (with for example a slight modification brought to the reference font) or have a different font style.

The changes between the first font and the modified font may be subtle, requiring careful and slow examination when the authentication of the document is performed by a human operator. There is therefore a need for a fast and reliable solution for automatic examination of such a security feature.

It is known from the [Lu, 2020] a method for detecting forged text in a document that classifies a document as fraudulent or authentic based on a Discrete Cosine Transform (DCT) of the document followed by an inverse DCT applied to the positive and negative coefficients of the DCT. This method does not enable specifically detecting a tampered font but instead aims to find any change in general, not specific to font style change as it relies on an overall change in the distribution of intensity of the pixels of a document which has been tempered.

### SUMMARY

This disclosure aims at improving the situation.

In particular, one aim of the present disclosure is to provide a fast and reliable solution for automatically authenticating a document based on the verification of a modified font.

Another aim of the present disclosure is to provide a method that can accommodate various types of modified fonts, including various characters and various types of modifications to the fonts.

Accordingly, a computer-implemented method for authenticating a document is disclosed, the document including a plurality of text fields, wherein an authentic document comprises, among the plurality of text fields, a plurality of characters printed according to a reference font, and at least one character, of determined location, being printed according to a font which is modified with respect to the reference font, the method comprising:
receiving an image of the document to be authenticated,
extracting, from the image, a region of interest including the character of determined location,
assessing discrepancies between the character included in the extracted region of interest and a model character, and
determining whether or not the document is authentic based on the assessed discrepancies.

In embodiments, the model character is a reference template of the character printed according to the reference font or according to the modified font, and assessing discrepancies between the character included in the extracted region of interest and the reference template comprises computing difference in intensities between the two characters.

In embodiments, determining whether or not the document is authentic is based on detection of intensity discrepancies or on the locations of intensity discrepancies. In one embodiment, the model character is a reference template of the character printed according to the reference font, and assessing discrepancies between the character included in the extracted region of interest and the reference template further comprises determining locations of extrema of the intensity difference between the two characters, and comparing the determined locations of the extrema with reference locations of the differences. According to this embodiment, the document is determined to be authentic when a distance between the determined locations of the difference extrema and the reference locations is below a determined threshold.

In another embodiment, the model character is a reference template of the character printed according to the modified font, and assessing discrepancies between the character included in the extracted region of interest and the reference template further comprises determining whether at least one intensity difference exceeds a predetermined threshold. According to this embodiment, the document is determined to be fraudulent when at least one intensity difference exceeds a predetermined threshold.

In one embodiment, the character model is a reference template of the character printed according to the reference font or the modified font, and the method comprises, prior to assessing discrepancies between the character included in the region of interest and the reference template a preprocessing of the region of interest to align the character included in the region of interest with the reference template. The preprocessing may include iteratively modifying the region of interest by implementing one of a rotation, translation, and rescaling of the character until the modified region of interest best fits the reference template. This enables increasing the reliability of the comparison with the reference template.

In one embodiment, extracting a region of interest including a character comprises extracting a patch of the image including the character, normalizing the intensity of the patch, extracting and optionally resizing a bounding box of the character, the extracted bounding box forming the region of interest.

In one embodiment, the method further comprises:
Processing the received image to determine a document type,
Accessing a database comprising, for each of a plurality of document types, data descriptors of the character according to the modified font, including at least the determined location of said character, and data descriptors of the model character, and
Retrieving from the database, the data descriptors corresponding to the determined document type.

In embodiments, the character model is a reference template of the character printed according to the reference font.

In embodiments, the document includes a plurality of static text fields, and the character printed according to the modified font is located within one of the static text fields.

In embodiments, an authentic document comprises at least two occurrences of the same character, wherein at least a first occurrence of the character is printed according to the modified font, and at least a second occurrence of the character is printed according to a reference font, and the method further comprises acquiring the reference template from the document to be authenticated, at a location corresponding to the second occurrence of the character, and acquiring the reference template from the image includes extracting a patch comprising the character according to the reference font from the image, normalizing the intensity of the patch and extracting a bounding box of the character, the extracted bounding box forming the reference template. In embodiments, the bounding box may be tightened around contours of the character included in the region of interest.

The disclosed method enables automatically verifying a modified font as a security feature of a document, by comparing a region of interest including a determined character that is the supposed to be printed according to the modified font (if the document is authentic) with a model of the character. In one embodiment, the determination of the authenticity of the document is based on the locations of the discrepancies between the compared characters. Accordingly, one only needs to rely on reference locations of the discrepancies, and for example not to the exact shape of the compared characters. The method is thus not tailored for a specific character or type of modification, and thus can accommodate a wide variety of types of font modifications, depending for instance of a type of document (e.g. Identity card, passport, visa, driving license, etc.), and depending on the issuing authority of the document.

Accordingly, at document authentication, the region of interest extracted from the document may be subject to a preprocessing consisting in the font alignment (for searching the best-fit location) and to a font normalization in intensity and size. At enrollment, a reference template may also be created going through the same extraction of a region of interest but without the step of alignment applied (since the exact font position for the reference template is known and the template acquired at enrolment is to be used as a reference). Accordingly, normalisation of size allows to compare fonts of same width and aspect ratio.

The method may rely on the use of a database of descriptors of character printed according to modified font and, optionally, according to the reference font for each of a plurality of document types. At each document authentication, the controlling authority may access said database to retrieve the relevant descriptors for the considered document type and perform the modified font verification based on said descriptors. The database may be updated regularly (including, for instance, changing the character concerned by the modified font, its location, or the type of modification) without modifying the implementation of the method.

According to another object, it is disclosed a computer-implemented method of generating a database for document authentication, comprising adding to the database, for each of a plurality of document types, data descriptors of at least one character model and of at least one character printed according to a modified font with respect to a reference font, including at least a determined location, in an authentic document, of the character printed according to the modified font.

In embodiments, the method of generating the database comprises preliminary steps, for each document type, of:
Receiving an image of a template of an authentic document,
Extracting, from the received image, a region of interest comprising a character,
Processing the extracted region of interest to obtain a template of the character, and
Recording, in the database, data descriptors of the template.

In embodiments, the data descriptors of the template which are recorded in the database include the template itself.

According to another object, a computer program product is disclosed, comprising instructions to implement the method according to the description above, when it is executed by a computer.

According to another object, a non-transient computer-readable recording medium is disclosed, on which code instructions are stored which, when executed by a computer, cause said computer to implement a method according to the description above.

According to another object, a document authentication system is disclosed, comprising at least an image sensor, adapted to acquire an image of a document to be authenticated, a database storing, for each of a plurality of document types, data descriptors of the model character and of the character printed according to the modified font, including at least a determined location, in an authentic document, of the character according to the modified font, and a computer, configured to receive images acquired by the image sensor and to implement the method according to the description above.

In embodiments the data descriptors further include at least one of:
a reference template of the character printed according to the modified font or printed according to the reference font,
An expected location of each discrepancy between the model character and the character printed according to the modified font.
a height, width, or aspect ratio of the model character,
expected locations of extrema of intensity discrepancies between the character according to the modified font and the character according to the reference font,
threshold values regarding intensity discrepancies, or locations thereof, between a character and a reference template thereof.

### BRIEF DESCRIPTION OF DRAWINGS

Other features, details and advantages will be shown in the following detailed description and on the figures, on which:

FIG. 1 represents examples of a same character (letter “T”) printed according to different fonts.

FIG. 2 schematically represents a document authentication system according to embodiments.

FIG. 3 schematically shows the main steps of a method for authenticating a document, according to embodiments.

FIG. 4 schematically shows the main steps of a method for generating a database for document authentication according to embodiments.

FIG. 5 schematically shows an example of discrepancies between two characters according to different fonts.

### DESCRIPTION OF EMBODIMENTS

With reference to the figures, a method and system for document authentication will now be described.

The document may be a document issued by an authority which attests of owner's specific information, such as its identity and/or rights. The document may for instance be an identity document such as an identity card or a passport. Other types of documents are also encompassed within the present disclosure, such as a visa, a license (e.g. driving license), a health insurance card, a membership card, etc. The document includes a plurality of static text fields and a plurality of variable text fields, where the latter may include Personal Identifiable Information.

The composition of a document, in particular the number and location of text fields, the content of the static text fields, the choice of the font and its size, depends on the type of the document, where the “type” relates both to the nature of document, i.e. the nature of information or right that is attested by the document (e.g. Passport, visa, driving license), and to the issuing authority of the document (ex. State). According to an example, an ID Card delivered by a country may not have the same disposition, text fields, fonts, etc. as an ID card delivered by another country.

According to the present disclosure, an authentic document comprises, among the plurality of text fields, a plurality of characters printed according to a reference font, and at least one character printed according to a modified font, with respect to the reference font. Within the present disclosure, the word “character” refers to an individual letter, number, or symbol printed on a document. The word “font” refers to a consistent design and style with which are printed characters, whereby different fonts can vary in attributes such as space, size, spacing, and weight (thickness of the character's stokes).

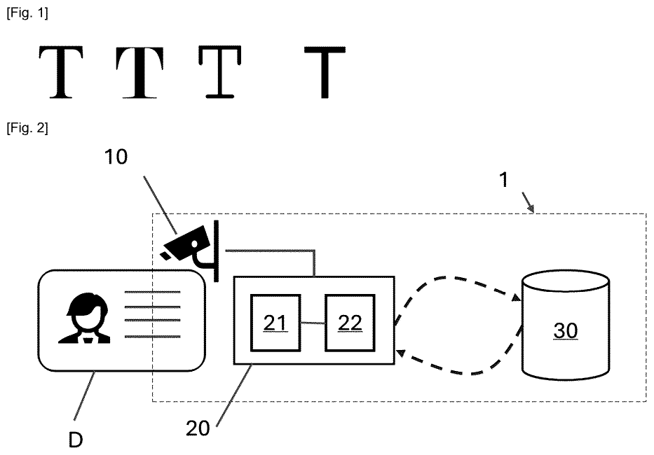

The modified font may be a different font from the reference font. With reference to FIG. 1, are shown a plurality of occurrences of the same letter “T” printed according to four different fonts. Alternatively, the modified font may be a font that comprises slight modifications brought to the reference font, such as, for instance, a change in the font thickness or height, or a line crossing the font, etc.

The character printed according to the modified font is a security feature of the document. Accordingly, said character is of determined location. The determined location may be a predetermined, constant location within the document. For instance, the character printed according to the modified font may be a determined character among one of the static text fonts (e.g. “the letter E in the static text font “NAME”). In that case, both the type of character (which letter or number or symbol) and its location within the document is known and constant. Alternatively, the location of the character may be determined according to a predefined rule. In this case, the character printed according to the modified font may also be a character of one of the variable fields and hence the specific type of character may not be fully determined or may be selectable within a list. According to non-limiting examples, the predefined rule may be that the character according to the modified font corresponds to the second number of the month of the data of birth, or the first vowel found in a given variable field, etc.

With reference to FIG. 2, the method may be implemented by a document authentication system 1. The document authentication system may be located at any premises where the user's identity or rights need to be checked. For instance, the document authentication system may be located at a boarding gate or terminal (in airports, train stations, harbours, etc.), customs, embassies, police stations, etc. The document authentication system 1 comprises an image sensor 10, for instance a camera, configured to acquire an image of the document D. In embodiments, the camera is configured for acquiring images of the documents at a resolution larger than 150 DPIs (dots per pixel). The document authentication system 1 further comprises a computer 20, which includes at least a processor 21 configured for implementing the method disclosed below, and a memory, storing code instructions executed by the processor for the execution of the method. The computer 20 may be collocated with the image sensor 10, i.e. on the premises where document authentication is implemented, or may be distant and remotely accessed via a telecommunications network.

The document authentication system 30 further comprises a database storing, for each of a plurality of document types, data characterizing the document type, and data enabling the implementation of the authentication method. In particular, the database includes at least, for each document type, data descriptors of the character printed according to the modified font, which may include at least the location of said character. The location may be expressed directly, for instance in terms of coordinates within the document, when the modified font is located in a static text field, or it may be expressed by a rule enabling to retrieve the character according to the modified font. As developed in more details below, the database may also store other data descriptors relative to the character printed according to the modified font, as well as data descriptors relative to a model character, for instance a reference template of the character printed according to the reference font.

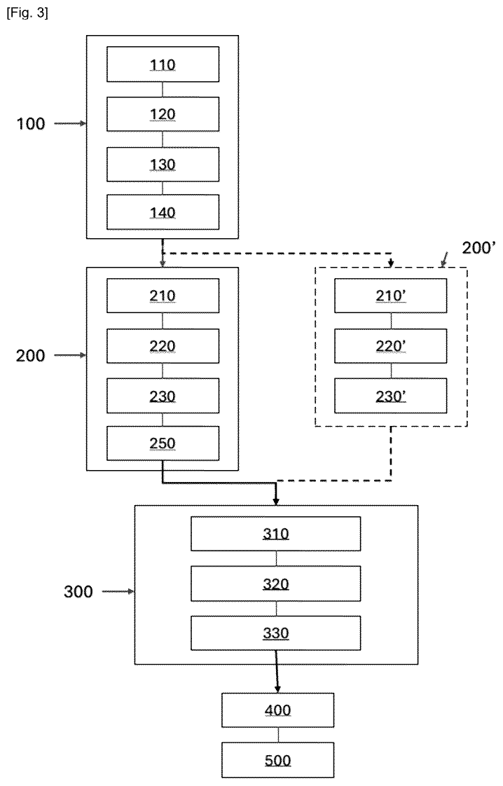

Embodiments of a method for authenticating a document will now be described with reference to FIG. 3. The method comprises a first step 100 of acquiring and processing an image of the document D to be authenticated. When a user accesses premises of document authentication, it may be invited by a system or a person to exhibit the document, and the image sensor 10 may capture an image of the document. The computer 20 thus receives during a step 110 an image of the document D to be authenticated that has been acquired by the image sensor.

The method then comprises a step 200 of extracting, from the received image, a region of interest including a character corresponding to the determined location of the character printed according to the modified font, in an authentic document.

In embodiments, the document authentication system 1 may be configured to perform authentication of a plurality of types of documents. In that case, the document authentication system may need to determine the location of the region of interest to extract according to the document type. Accordingly, prior to implementing step 200, the image may be processed 120 to determine the type of document it relates to. Said processing may comprise extracting from the document information enabling to determine its type. Said information may include identification of the nature of document that is apparent on the document and identification of the issuing authority. Before determining the type of document, the processing may also include a processing to normalize the image, which may include one of cropping, or segmenting the document within the image, or other operations of rotation, resizing and flat-rendering of the document.

Once the document type is determined, the computer 20 may then access 130 the database 30 to recover 140 from the database, based on the document type, the location of the character which, in authentic documents, is printed according to the modified font. As mentioned above, the location may be explicit or may correspond to a rule for determining the character within the document. The extraction 200 of the region of interest is then implemented according to said determined location.

In embodiments, the extraction 200 of the region of interest comprises extracting 210 a patch of the image including the character, normalizing 220 the intensity of said patch (e.g. to bring the darkest pixels of the patch to a predefined maximum value, and the lightest pixels of the patch to a predefined minimum value), and extracting 230 a bounding box around contours of the character contained in the patch. The bounding box may be tightened around contours of the character, i.e. contain nothing else than the character itself. The size of the bounding box may also be normalized. The extracted bounding box then forms the region of interest.

The method then comprises assessing 300 discrepancies between the character included in the extracted region of interest and a character model, and determining 400 whether or not the document D is authentic based at least on the assessed discrepancies. According to variants of the present disclosure, the document may comprise a plurality of security features, and the determination 400 of the authenticity of the document is based not only on the verification of the character according to the modified font, but also on the verification of other security features. Nevertheless, the assessment of discrepancies between the character and the character model may allow, alone, to determine the document as fraudulent. In that case, the method may further comprise a step 500 of at least one of rejecting authentication, issuing an alert, prompting the user to re-try a document authentication, etc.

The character model is a piece of data representing the ground truth for the character printed either according to the reference font, or according to the modified font. In embodiments, the character model may be a reference template of the character printed according to the reference font, or according to the modified font. A reference template of a character is an explicit representation of the character that serves as ground truth for the step of assessing discrepancies. Alternatively, the step of assessing the discrepancies may be performed based on a deep learning approach, whereby the model character is not a single template representing the character but is learnt during training of the deep learning model.

In embodiments, particularly when the reference template of the character is printed according to the reference font, the reference template may also be extracted from the image of the document. Indeed, an authentic document may comprise, within the plurality of text fields, and especially within the plurality of static text fields, a plurality of occurrences of the same character, where at least one occurrence is printed in the reference font and at least one other occurrence is printed according to the modified font. In that case, the character extracted at step 200 may be compared with a reference template obtained from the occurrence of the same character printed in the reference font.

In that case, the method comprises an additional step 200′ of extracting the reference template used as character model from the image. The same steps as in step 200 may be performed, i.e. a patch comprising the character according to the reference font may be extracted 210′ from the image, then the intensity of the patch may be normalized 220′ and a bounding box around contours of the character may be extracted 230′, thereby forming the reference template.

In embodiments, the database 30 further comprises, for each document type, a location within the document where the reference template can be extracted, and the computer retrieves said location during step 140 prior to performing the extraction 200′ of the reference template.

Alternatively, the reference template is not extracted from the document, but may be stored in the database 30. In this case, the reference template is retrieved by the computer during step 140, from the determined document type.

In embodiments, for instance when the character according to the modified font is a character of a variable text field, and may hence be chosen among a plurality of different characters, the database may store a reference template of each character, and the computer may retrieve the reference template corresponding to the character extracted from document D based on a comparison of similarity between the extracted region of interest comprising the character and the reference templates stored in the database.

Optionally, prior to assessing 300 discrepancies between the extracted region of interest comprising the character and the reference template, the method may comprise a preprocessing 250 of the region of interest to align the character included in the region of interest with the reference template. Said alignment can comprise iteratively modifying the region of interest by implementing at least one of a rotation, translation, and scaling, until the modified region of interest best fits the reference template, in order to improve accuracy of the subsequent assessment step 300. This preprocessing may take into account data descriptors associated to the reference template such as font width, font aspect ratio, height, that may either be stored in the database and retrieved at step 140, or derived from the reference template.

The assessment of discrepancies 300 between the extracted region of interest and the reference template is performed in order to determine whether the character is indeed printed according to the modified font, and whether the modification of the font with respect to the reference font are authentic. This assessment is performed based on the intensities of the two characters, without taking into consideration the background of each character.

In embodiments, assessing discrepancies 300 comprises computing 310 difference in intensities between the two characters, and determining the locations 320 of the extrema of the intensity difference between the two characters. Determining the locations of the extrema enables considering only the changes between the fonts, and not potential variations in intensity that may remain between the extracted region of interest and the template. With reference to FIG. 5, are schematically shown examples of locations of discrepancies between the intensities of the two compared characters (the locations are shown by the squares on the right-hand side character).

When the reference template is a template of the character according to the reference font, the locations of the extrema of the intensity differences between the two compared characters may be compared 330 with reference locations of the discrepancies between the modified template and the reference template, and a distance between said locations may be computed and compared with a predetermined threshold. Indeed in that case, discrepancies are expected between the modified font and the reference template, and the locations of these discrepancies are known. The reference locations, as well as the threshold(s) for comparison, may also be part of the descriptors stored in the database for each document type and retrieved by the computer at step 140. The document is then determined 400 to be authentic when the computed distance between the locations of the extrema in intensity difference and the reference locations is below a determined threshold.

Alternatively, when the character within the region of interest is compared with a reference template of the character according to the modified font, no discrepancy is expected. Hence, a comparison is performed at step 330 between the intensity differences between the two compared characters, or the maximal intensity difference, and a predetermined threshold, which may also be stored in the database for each document type and retrieved by the computer at step 140. When an intensity difference higher than a determined threshold is detected, then the document is determined to be fraudulent.

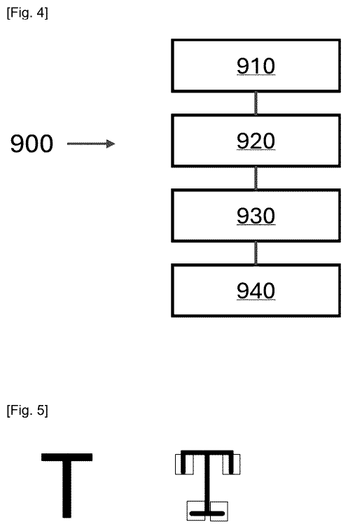

According to another object, a method 900 for generating a database 30 for document authentication is disclosed, with reference to FIG. 4. The database may be initialized, for each document type, with the nature of the document and an indication of its issuing authority. Furthermore, the method comprises adding 940 to the database, for each document type, data descriptors enabling later implementation of the authenticating method, including data descriptors of at least one model character, and of at least one character printed according to a modified font, the latter including at least a determined location, in an authentic document, of the character printed according to the modified font.

In embodiments, the data descriptors of the model character may include a location, within an authentic document, at which a reference template of the character printed according to the reference font can be extracted. In other embodiments, the data descriptors of the model character may include a reference template of the character printed according to the reference font or a reference template of the character according to a modified font. In this case, the generation of the database includes enrollment of at least one reference template for each of document type.

Said enrollment may include reception 910 of at least one image of a template of an authentic document. By “template of an authentic document”, is meant a standardized model or layout that outlines the structure and design of the document. It includes predefined elements, in particular the static text fields of the document. The received image may be processed to normalize the image, which may include one of cropping, or segmenting the document within the image, or other operations of rotation, resizing and flat-rendering of the document.

The enrollment may further include extracting 920, from the received image, a region of interest comprising a character, and the processing 930 of said region to obtain a template of the character, which will be used as the reference template during implementation of the authentication method. The processing 930 may be performed according to steps 200, 200′ recited above, i.e. it may include extracting a patch including the character, normalizing the intensity of the patch and extracting a bounding box tightened around the contours of the character, which size may also be normalized.

The obtained reference template may be recorded in the database. In embodiments, the enrollment may further comprise recording, in the database, data descriptors regarding the reference template, such as the font's height, width, aspect ratio, etc.

In embodiments, when the reference template is according to the reference font, the generation of the database may also include recording, in the database, additional data descriptors related either to the modified font, which may include height, width, aspect ratio, and/or data descriptors relative to discrepancies between the character according to the reference font, and the same character according to the modified font, such as the expected locations of extrema of intensity discrepancies between the characters, and one or more threshold(s) regarding said locations.

When the reference template is according to the modified font, the generation 900 of the database may also include recording, in the database, a threshold value regarding the maximum accepted intensity discrepancy between the compared characters.

### BIBLIOGRAPHY

[Lu, 2020]: Y. Lu et al., “A New Method for Detecting Altered Text in Document Images,” International Conference on Pattern Recognition and Artificial Intelligence (ICPRAI), LNCS 12068, pp. 93-108, 2020.

1. A computer-implemented method for authenticating a document, the document including a plurality of text fields,
wherein an authentic document comprises, among the plurality of text fields, a plurality of characters printed according to a reference font, and at least one character, of determined location, being printed according to a font which is modified with respect to the reference font,
the method comprising:
receiving an image of the document to be authenticated,
extracting, from the image, a region of interest including the character of determined location,
assessing discrepancies between the character included in the extracted region of interest and a model character, and
determining whether or not the document is authentic based on the assessed discrepancies.

2. The method according to claim 1, wherein the model character is a reference template of the character printed according to the reference font or according to the modified font, and assessing discrepancies between the character included in the extracted region of interest and the reference template comprises computing difference in intensities between the two characters.

3. The method according to claim 2, wherein determining whether or not the document is authentic is based on detection of intensity discrepancies or on the locations of intensity discrepancies.

4. The method according to claim 2, wherein the model character is a reference template of the character printed according to the reference font, and assessing discrepancies between the character included in the extracted region of interest and the reference template further comprises determining locations of extrema of the intensity difference between the two characters, and comparing the determined locations of the extrema with reference locations of the differences.

5. The method according to claim 4, wherein the document is determined to be authentic when a distance between the determined locations of the difference extrema and the reference locations is below a determined threshold.

6. The method according to claim 1, wherein extracting a region of interest including a character comprises extracting a patch of the image including the character, normalizing the intensity of the patch, extracting and optionally resizing a bounding box of the character, the extracted bounding box forming the region of interest.

7. The method according to claim 1, wherein the character model is a reference template of the character printed according to the reference font.

8. The method according to claim 1, wherein the document includes a plurality of static text fields, and the character printed according to the modified font is located within one of the static text fields.

9. The method according to claim 7, wherein an authentic document comprises at least two occurrences of the same character, wherein at least a first occurrence of the character is printed according to the modified font, and at least a second occurrence of the character is printed according to a reference font, and the method further comprises acquiring the reference template from the document to be authenticated, at a location corresponding to the second occurrence of the character, and acquiring the reference template from the image includes extracting a patch comprising the character according to the reference font from the image, normalizing the intensity of the patch and extracting a bounding box (tightened around contours) of the character, the extracted bounding box forming the reference template.

10. A computer-implemented method of generating a database for document authentication, comprising adding to the database, for each of a plurality of document types, data descriptors of at least one character model and of at least one character printed according to a modified font with respect to a reference font, including at least a determined location, in an authentic document, of the character printed according to the modified font.

11. A document authentication system, comprising at least an image sensor adapted to acquire an image of a document to be authenticated, a database storing, for each of a plurality of document types, data descriptors of the model character and of the character printed according to the modified font, including at least a determined location, in an authentic document, of the character according to the modified font, and a computer configured to receive images acquired by the image sensor and to implement the method according to claim 1.

12. The document authentication system according to claim 11, wherein the data descriptors further include at least one of:
a reference template of the character printed according to the modified font or printed according to the reference font,
An expected location of each discrepancy between the model character and the character printed according to the modified font.
a height, width, or aspect ratio of the model character,
expected locations of extrema of intensity discrepancies between the character according to the modified font and the character according to the reference font,
threshold values regarding intensity discrepancies, or locations thereof, between a character and a reference template thereof.
